(19) United States
(12) Patent Application Publication
(10) Pub. No.: US 2004/0009804 A1
(43) Pub. Date: Jan. 15, 2004

(54) Gaming method and apparatus

(76) Inventor: Suzie Dumont, Montreal (CA)

Correspondence Address: STERNE, KESSLER, GOLDSTEIN & FOX PLLC, 1100 NEW YORK AVENUE, N.W., WASHINGTON, DC, 20005, US

(21) Appl. No.: 10/448,307

(22) Filed: May 30, 2003

Related U.S. Application Data
(60) Provisional application No. 60/383,803, filed on May 30, 2002.

(51) Int. Cl. A63F 13/00

(52) U.S. Cl. 463/16

(57) ABSTRACT

The present invention provides a lottery-type game which comprises an image which may be divided into a number of regional images. A number of symbols are represented within the image and associated regional images and during play of the lottery-type game a player attempts to locate as many of these symbols as possible. Upon locating a predetermined number of symbols, a player will be awarded a prize and the value of the prize may be determined based on the number of specific symbols located, wherein the identity of the specific symbols can be presented to the player prior to the commencement of play in the form of target symbols.

### FIELD OF THE INVENTION

The present invention relates to the field of games and gaming methods.

### BACKGROUND OF THE INVENTION

A number of electronic gaming devices, including those commonly found in gaming casinos, include a visual display which show a number of gaming symbols. In previous gaming devices each of these symbols typically have the potential to change from one round of a game to the next. For example, in a simulated slot machine, the symbols that are displayed to simulate the symbols that appear when slot machine reels have stopped are gaming symbols and have the potential to change with each handle pull or other play of the slot machine.

In some situations it is desirable to provide the player with a measure of decision making by which the player can optimize his/her chances of winning. This increases player involvement and entertainment value. Draw Poker games where a player chooses which cards to keep and which to discard are a good popular example of a game with an “optimizing” skill.

In some situations, it is desirable to provide a gaming environment in which players are motivated to play multiple rounds of a game. What constitutes a “round” of a game varies from game to game, but is generally initiated by a user providing an input that signals the user's desire or commitment to playing the round, such as pulling a handle, pushing a button and the like, often accompanied by the placing of a bet or wager. Typically, payment of a monetary prize or the awarding of points or credits is done only in response to the playing of a round of a game. For example, a round of a reel slot machine game (often referred to as a “spin”) typically involves pulling the slot machine handle, waiting for the reels to stop spinning, evaluating the results, and giving any awards won.

It is believed an environment which encourages play of multiple rounds of a game would add to the player's interest in a particular game, thus increasing entertainment value, and potentially increasing revenue to the casino or other game operator. However, previous gaming environments which provide for a playing field in which symbols can always change from round to round (i.e. in which the symbols displayed on a gaming field are always independent of one another) has provided little opportunity to encourage players to play multiple rounds of a game. Furthermore, most casino type games do not reveal the winning parameters prior to commencing play of a game.

Thus, there is a need in the gaming art for new games that will encourage play of multiple rounds of a game, add to a player's interest in a particular game, and increase entertainment value.

### SUMMARY OF THE INVENTION

An object of the present invention is to provide a game method and apparatus. In accordance with one aspect of the invention there is provided a gaming method comprising the steps of: displaying an environment image to a player on a display medium; displaying identifiable symbols within the image; displaying target symbols associated with prizes that may be awarded upon identification of the identifiable symbols by the player; enabling player to search for identifiable symbols within the image; enabling player to select said identifiable symbols within the image; and awarding prize to the player for locating identifiable symbols within the image which match a corresponding number of target symbols; wherein the gaming method may be played in an electronic or static medium.

In accordance with another aspect of the invention there is provided a gaming apparatus comprising: a game record storage device for storing a plurality of environment images, these images comprise identifiable symbols therein; a gaming terminal having an activation means; a communication arrangement for facilitating communications between the game record storage device and the gaming terminal; and a player input arrangement for (i) enabling a player to search for identifiable symbols within the image (ii) enabling a player to select identifiable symbols within the image and (iii) awarding prizes to the player for locating identifiable symbols within the image.

In accordance with another aspect of the invention there is provided a program product comprising a computer readable medium having a computer program recorded therein for performing/executing a gaming method comprising the steps of: displaying an environment image to a player on a display medium; displaying identifiable symbols within the image; displaying target symbols associated with prizes that may be awarded upon identification of identifiable symbols by the player; enabling player to search for the identifiable symbols within the image; enabling player to select identifiable symbols within the image; and awarding prize to the player for locating identifiable symbols within the image which match a corresponding number of target symbols.

### BRIEF DESCRIPTION OF THE DRAWINGS

FIG. 1 illustrates the lottery type game as it may be presented to a player according to one embodiment of the present invention.

FIG. 2 is a flow diagram illustrating the sequence of play according to one embodiment of the present invention.

### DETAILED DESCRIPTION OF THE INVENTION

Definitions

The term “image” is used to define a 2D or 3D representation which defines the area in which the game is to be played, for example a picture, a photograph, drawing or the like.

The term “regional image” is used to define a portion of the image. The term “sub-image” is used to define a 2D or 3D representation, for example a picture, photograph, drawing or the like, which is not visible upon inspection of the image or regional image, however a sub-image is associated with an object presented in the image. For example, a sub-image may represent the inside of a treasure chest which can be found in the image or regional image. The sub-image may alternatively represent what would be seen if one used a device shown in the image. For example, if a microscope is found in the image, a sub-image corresponding to the microscope may represent what is being viewed through the microscope.

The term “transitional object” is used to describe a pictoral image of an object which provides a “gateway” to a sub-image. For example, a transitional object may be a treasure chest and upon selection of the treasure chest the sub-image of the interior of the treasure chest is displayed.

The term “symbol” is used to describe any distinguishable representation, which is positioned within the image, regional image and/or sub-image in a manner that it can be located by a player during play of the game and may be, for example, but not limited to a picture of an object, letter or number or any other identifiable graphical representation.

The term “target symbol” is used to describe a symbol which is presented to a player and may correspond to one or more of the symbols contained within the image, regional image and/or sub-image. The target symbol represents the identity of symbols to be located within the image, regional image and/or sub-image by a player during play of the game.

Unless defined otherwise, all technical and scientific terms used herein have the same meaning as commonly understood by one of ordinary skill in the art to which this invention belongs.

The present invention provides a lottery-type game which comprises an image which may be divided into a number of regional images. A number of symbols are represented within the image and associated regional images and during play of the lottery-type game a player attempts to locate as many of these symbols as possible. Upon locating a predetermined number of symbols, a player will be awarded a prize and the value of the prize may be determined based on the number of specific symbols located, wherein the identity of the specific symbols can be presented to the player prior to the commencement of play in the form of target symbols.

Game Environment

The game environment represents the playing domain of the game of the present invention. The game environment comprises an image which can be a 2-dimensional or 3-dimensional representation or picture which may have a particular theme. For example, the image may be a pictoral representation of an attic, stable, antique shop, laboratory, harbour, garden or other type of environment including objects that may typically be found within the particular environment. The theme of the image may provide stimuli for the enjoyment of the game by a player and thereby maintain a player's interest and may enhance the playing experience.

The image may be divided into a number of regional images, wherein each regional image represents a portion of the complete image. A regional image may provide a player with enhanced detail of a particular portion of the image, possibly provided by enlarging the specific area of the image represented by the regional image. In this manner a player may be able to identify symbols within the regional image which may not have been identifiable when the entire image was presented. During play of the game a player is provided with a means to navigate through the image and regional images and may be able to actively move between the regional images of the image. This ability may be enabled if the game is embodied on an electronic medium, for example.

The game environment further comprises a number of sub-images which are components of the image or regional image but can be accessed through the activation of a transitional object. A sub-image defines a pictorial representation which can be associated with the transitional object. For example, a transitional object may be a chest and a sub-image associated with the chest can represent the interior thereof. Alternatively, a transitional object may be a microscope and the associated sub-image may be what one would see through the microscope. Additionally, the transitional object may be a door and the associated sub-image may represent what can be seen upon opening the door. These are provided as examples and any number of transitional objects may have a sub-image associated therewith, for example alternate transitional objects may be a telescope, video camera, camera, binoculars or a window.

In addition a number of symbols are represented within the image, regional images and/or sub-images in a manner that they may be located by a player during play of the game. For example, the symbols may be represented within the image such that they may be easily located by a player or they may be hidden within the image in a manner that a player is required to explore the image in a more detailed manner.

In one embodiment, a symbol may be represented within a sub-image and may only be located if a player enters this sub-image. For example, if a chest is represented within the image and this chest is a transitional object having a sub-image associated therewith, a symbol may be hidden within the chest wherein the inside of the chest may be presented to a player upon selection of the transitional object.

In a typical game, a player is presented a number of target symbols which may match one or more of the symbols which are represented within the image or portions thereof. In one embodiment, the target symbols are displayed at a location removed from the image but in close proximity of this image thereby presenting both the target symbols and the image within the full view of a player. In one embodiment of the invention, the number of target symbols which match the symbols located by a player during play of the game, determines the value of the prize won by the player. For example, three specific target symbols can be associated with a particular prize, therefore upon the identification of symbols within the image, regional images, and or sub-images, that correspond to each of the three specific target symbols, the player will with that particular prize.

In one embodiment, there is also provided a counting device which provides a player with information relating to the number of symbols which have been located within the image and which match the required target symbols. In this manner a player is able to monitor their progress and determine the required symbols which are to be located within the image in order to win a prize. In one embodiment, there is provided a further counting device which provides a player with the total number of symbols within an image and may indicate the number of symbols which are still to be located within the image. In this manner a player is provided with an additional indicator of their progress towards the completion of the game and the potential prize or prizes that may be won.

Playing the Game

A player is provided with a means for navigation within the game environment thereby enabling a player to locate symbols represented in the image, regional images and/or sub-images. For example, in a computer operated version of this type of game, a player may use a cursor, mouse, roller ball, light pen, touch screen, joy stick or any other type of user operated input device compatible with the computing system being used. In this manner a player can select a particular regional image or portion of the image in which they desire to look for the symbols. For example, upon selection of a regional image, this related portion of the image may be enlarged thereby enabling a closer inspection of its contents by the player.

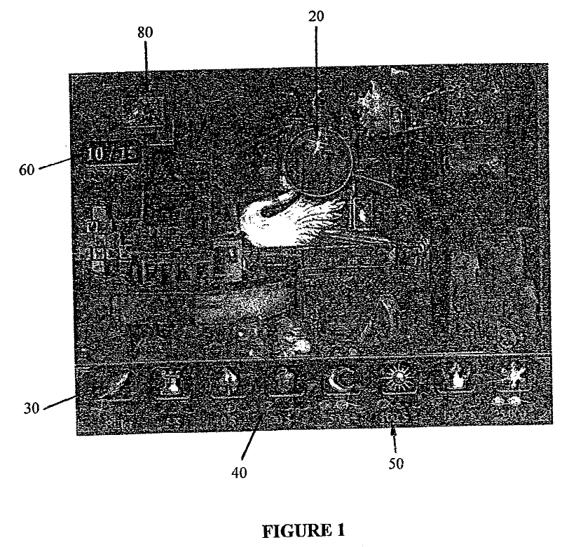

For example, a cursor may be moved around the game environment by the use of a player input device, for example a mouse, joy stick, light pen or the like. The cursor may take a number of different shapes for example a magnifying glass, pointer, or any other shape which may be considered appropriate by a worker skilled in the art. In one embodiment and with reference to FIG. 1, a magnifying glass represents the cursor and further enlarges the area being viewed by the magnifying glass, thereby representing what would occur during the use of a magnifying glass in reality.

In one embodiment, a transitional object may be identified by a change in this object's appearance upon visual inspection or selection of the transitional object, for example it may illuminate when a player moves the cursor over it. In this manner, during exploration of the image, a player is able to identify which objects are transitional objects having sub-images associated with them. A player is then able to establish alternate areas in which they may be able to locate symbols. In one embodiment, a player may “click” on the transitional object in order to indicate that the sub-image associated therewith, is to be displayed. A number of other techniques may be used to gain entry into a sub-image by the selection of the transitional object, for example using a touch screen, a light pen or any other selection means that would be known to a worker skilled in the art and would be dependent on the medium upon which the game is being played.

In an electronic version of the game according to the present invention, there are a number of different methods which may be used by a player to select or identify a symbol which has been located within the image. For example, a player may “click” on a located symbol using a mouse, or may touch the symbol if the gaming device is equipped with a touch screen interface or the player may identify a symbol using a light pen or other optical selection device. Other methods of selecting the located symbol would be known to a worker skilled in the art and would be dependent on the gaming device associated with the game.

In one embodiment, upon selection of a located symbol, the symbol may illuminate and subsequently disappear, or it may remain illuminated thereby indicating the selection of the symbol by the player. In addition, upon the selection of the symbol, a counter may be adjusted to inform the player that the symbol has been located and selected, wherein this counter can be presented to the player using the gaming medium for example.

There are a number of different ways that a player may win the game according to the present invention. For example, if a player is able to located symbols which match a predetermined number of target symbols, the player may win a predetermined prize. The value of this prize can be determined on the number of target symbols which were matched during play or alternatively the prize can be determined by the specific target symbol or symbols which are matched. For example and with reference to FIG. 1, a player wins $100 if they are able to locate three “sun” symbols within the image. An alternate or additional winning scenario may be determined based on the time required for the player to locate all of the symbols which are represented within the image. Additionally, if a player has selected a complex or cluttered image in which to search for symbols, the difficulty level associated with this image may be increased. The corresponding prizes associated with this particular image may be greater than those associated with a simpler, sparser image, for example. A worker skilled in the art of games would understand that there are a number of variations that can be devised in order to determine the awarding of a prize and the value of the prize.

In one embodiment, a gaming system operating the lottery-type game according to the present invention may comprise an assistance manager. For example, if a player is having difficulty locating symbols within the image, a player may request assistance from the gaming system. In response to this request the gaming system may provide a player with the identity of a regional image which contains a symbol or the system may indicate the exact location of a symbol. In this manner, a player may not become frustrated by not being able to locate any symbols, thereby possibly enhancing a player's enjoyment of the game.

Parameters and Variations

In one embodiment of the invention, a player may actively choose the theme of the image which is to be used during the play of the game. In this manner a player's interest may be maintained during play of the game if they are exploring an environment which is of interest to them, thereby possibly enhancing the playing experience.

In one embodiment, a lottery-type game according to the present invention may be of varying difficulties, which may be defined by the complexity of the environment image and how difficult it is to locate the identifiable symbols represented therein. In this manner a player may be able to select a particular difficulty level of the game to be played if this aspect is desired. For example an image that is cluttered with a number of objects would make it more difficult for a player to identify a symbol. Alternatively, a sparse image having a limited number of objects presented therein and may make it easier to locate a symbol. Additionally, the difficulty of the playing of the game may be adjusted by modifying the appearance of the symbol for example the modification of the texture, size, color or orientation of the symbol while the shape of the identifiable symbol remains unchanged can make the symbol easier to identify within the image, regional images and/or sub-images.

In one embodiment of the invention, the conclusion of the game may occur upon the identification of all of the identifiable symbols within the environment image by a player or if a player has located identifiable symbols within the environment image which match a predetermined number of target symbols. Alternately, a predetermined time period may be provided for a player to identify the symbols within the game environment and the game ends at the end of this time period irrespective of whether all of the symbols have been located or if an appropriate number of symbols which match the identified target symbols have been identified.

In one embodiment, a gaming system may further enable the saving of a game in progress. In this manner a player may be able to play a game according to the present invention for a period of time and save the present status of a particular game for completion at a later time. In this manner, a player is not necessarily required to play a game from start to finish, particularly if the game in question is of a difficult nature and/or there is a large number of symbols that can be identified in the image, regional images and/or sub-images.

In one embodiment of the present invention, once a player has located all symbols within an image, regional images and/or sub-images, the player may be asked if one wished to continue play of the game. This continuation of play may commence with the selection of a new theme and hence new image and the like, or the continuation of play may result in the addition on new symbols within the same image provided at the start of the game. In one embodiment, the continuation of play through the addition of new symbols can result in the level of difficulty increasing with each addition of a new set of symbols within a repeated image previously chosen by a player.

Gaming Mediums

In one embodiment, a gaming apparatus which is capable of enabling the play of a game according to the present invention comprises a gaming terminal which includes a display for displaying various game representations, and further includes an input device for receiving player inputs including game play requests. The input device may comprise any type of input arrangement including a keyboard, mouse, roller ball, joys tick, lever activated switches or one or more push buttons. The input device may optionally comprise a touch screen which may be integrated with the display. Each gaming terminal may also include an activation means for receiving payments from a player to activate the game and an arrangement for making pay outs to the player. The activation means may consist of a coin, paper money or credit card operated mechanism. Pay outs may be made using a coin or token dispensing arrangement included in the gaming terminal. Alternatively, or in addition to a coin dispensing arrangement, the gaming terminal may include a printer for printing a ticket showing the player's winnings thereby enabling the collection of the winnings at a dispensing wicket at a casino or a lottery game operator, for example.

In one embodiment, the gaming terminals comprise a processor for executing game control software which implements the gaming method. The processor also enables communication between the hardware and software of the gaming terminal in order to present a game to a player. Other forms of the invention may perform some or all of this game play processing at a central computer system. The invention is not limited to any particular processing arrangement, and any processing arrangement which performs the gaming method described in this disclosure is to be considered an equivalent.

In one embodiment of the present invention, program code for enabling the functionality of the game to be realised can be stored on a CD or DVD wherein this version of the gaming medium can be executed on a personal computer or like device for example. Allocation of monetary prizes may be done through completion of an image and and the prize associated with this form of the present invention may result in progressing to a more difficult level at which symbols are to be identified in the same or new image.

In one embodiment of the invention, the lottery-type game may be incorporated into a virtual reality type system, thereby enabling a player to more intimately interact with the game environment created for the play of the game. In this manner the game environment may become much more interactive as would be known to a worker skilled in the related art.

A worker skilled in the art would understand how to develop a computer program product which comprises a set of instructions contained on a computer readable medium which enables a player to play a lottery-type game according to the present invention.

In one embodiment of the present invention, the lottery-type game may be provided on a printed medium, for example a “scratch and win” lottery type ticket. The paper ticket may consist of a scratch off layer which covers the ticket wherein this layer has an image thereon for inspection by the player. The player proceeds to only scratch off the region of this scratch of layer where the player perceives there is a symbol matching a target symbol. If the scratched region of the layer does contain a symbol therein, the layer underneath the removed region may indicate a correct match either by the revealing of a representation indicating “correct” or a specific color that is identical to the target symbols, or an enlarged view of the symbol identified in order that the player may compare it with the target symbols identified on the ticket. The player may only have a specific number of scratches allocated for each ticket, wherein if more symbols are scratched than permitted, the ticket is void, for example. The paper ticket may also be void if the entire scratch off layer is removed from the the paper ticket. Under such an embodiment, every ticket can potentially be advertised as a winner if the player scratches the correct regions otherwise the player may not be allocated a prize. A worker skilled in the art would understand how to fabricate a lottery-type ticket which enables a player to play a game according to the present invention.

### EXAMPLE

FIG. 1 illustrates one embodiment of the lottery-type game as it may be presented to a player. In this figure a player has selected a particular region of the environment image, which has been enlarged as seen in the figure. The total environment image can be seen in the top right corner of FIG. 1 in a small scale, wherein the enlarged region as seen in the figure is identified by the region indicator 80, which is represented by a white box. In this example, the environment image represents a closet with a number of toys arranged therein and a number of symbols 20 are represented within the environment image. In this example, the searching tool is in the form of a magnifying glass and can be moved around the screen using a player input device. In addition, a number of target symbols 30 are presented to a player thereby indicating which symbols a player is required to locate within the environment image in order to win a prize. In FIG. 1, there is further provided a first counting device 40 which enables a player to monitor the number of target symbols 30 which have been matched by symbols 20 located by the player. Furthermore, each target symbol 30 may be associated with a prize 50 which may be awarded to a player once this player has located a predetermined number of symbols 20 which match the predetermined target symbols 30. In this example, a prize 50 is awarded if three of the symbols 20 located by the player match a specific target symbol 30. There also may be a second counting device 60 which defines the number of symbols 20 which still remain to be located within the environment image.

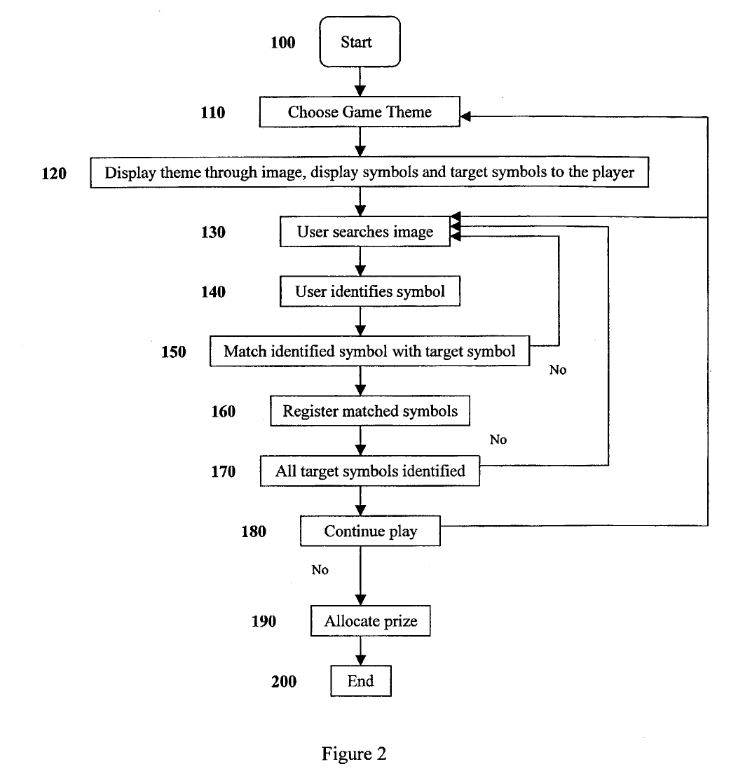

In one embodiment of the present invention and with reference to FIG. 2, the various sequence of steps performed during play of the game will be described. At step 100, a user initiates play of the game according to the present invention. Upon initiating play, the user will be asked to choose a game theme 110. Game themes may consist of a barn environment, lab, fire station, casino, tropical island, etc. Once a theme is chosen by the user, the gaming apparatus at step 120 will present to the player through a monitor, for example, the image associated with the theme previously selected, symbols within the image and targets symbols to be identified in the image. At step 130, the player will search the image for symbols that match the target symbols through the input devices associated with the device operating the game. Once the player identifies a symbol at step 140, the user will select it either by clicking on it or dragging it to a specific area. Once the user has identified a symbol, said symbol is subsequently compared with the target symbols provided by the game at step 150. If the selected symbol does not match a target symbol, the user is informed to continue searching the image for symbols and therefore returns to step 130. Otherwise, the symbol is registered as matching a target symbol at step 160. The gaming apparatus of the present invention will then proceed to determine if all target symbols have been identified at step 170 and if all target symbols are identified within the image presented to the player, the player is then requested if he wants to continue play at step 180. If the player chooses to continue play, the player will then be requested to choose a new theme and returned to step 110. If all of the target symbols are not identified, the player at will be directed to continue searching for symbols which are target symbols by returning to step 130. If at step 180 the player chooses not to continue play, a prize will be allocated at step 190 and the game will be terminated.

In another embodiment of the present invention, if the player has identified all target symbols within an image and chooses to continue play, the player may be directed to the same image with new symbols added to the image. The degree of difficulty can increase with each completed search for symbols in a particular image, i.e. all target symbols identified within a given image.

The above described preferred embodiments are intended to illustrate the principles of the invention, but not to limit the scope of the invention. Various other embodiments and modifications to these preferred embodiments may be made by those skilled in the art without departing from the scope of the following claims.

The embodiment of the invention in which an exclusive property or privilege is claimed are defined as follows:

1. A gaming method comprising the steps of:
(a) displaying an environment image to a player on a display medium;
(b) displaying identifiable symbols within said image;
(c) displaying target symbols associated with prizes that may be awarded upon identification of said identifiable symbols by said player;
(d) enabling player to search for said identifiable symbols within said image;
(e) enabling player to select said identifiable symbols within said image; and
(f) awarding prize to said player for locating identifiable symbols within said image which match a corresponding number of target symbols;
wherein the gaming method may be played in an electronic or static medium.

2. The gaming method of claim 1 wherein the image has transitional objects displayed therein.

3. The gaming method of claim 1 wherein the player may access regional images within the image

4. The gaming method of claim 2 wherein the player may access sub-images through the transitional objects.

5. The gaming method of claim 4 wherein the sub-images have target symbols.

6. The gaming method of claim 4 wherein the sub-images do not have any target symbols.

7. The gaming method of claim 1 wherein the image has a set number of symbols contained therein.

8. The gaming method of claim 1 wherein the display medium is a video monitor.

9. The gaming method of claim 1 wherein the environment image can be representative of a theme.

10. The gaming method of claim 1 wherein the static medium is a paper ticket.

11. The gaming method of claim 1 wherein the electronic medium is a software stored on a gaming terminal.

12. A gaming apparatus comprising:
(a) a game record storage device for storing a plurality of environment images, said images comprising identifiable symbols therein;
(b) a gaming terminal having an activation means;
(c) a communication arrangement for facilitating communications between the game record storage device and the gaming terminal; and
(d) a player input arrangement for (i) enabling a player to search for said identifiable symbols within said image (ii) enabling a player to select said identifiable symbols within said image (iii) awarding prizes to said player for locating said identifiable symbols within said image.

13. The gaming apparatus of claim 12 wherein the image has transitional objects displayed therein.

14. The gaming apparatus of claim 12 wherein a player may access regional images within the image.

15. The gaming apparatus of claim 14 wherein the player may access sub-images through the transitional objects.

16. The gaming apparatus of claim 15 wherein the sub-images have target symbols.

17. The gaming apparatus of claim 15 wherein the sub-images do not have any target symbols.

18. The gaming apparatus of claim 12 wherein the image has a set number of symbols therein.

19. A program product comprising a computer readable medium having a computer program recorded therein for performing/executing a gaming method comprising the steps of:
(a) displaying an environment image to a player on a display medium;
(b) displaying identifiable symbols within said image;
(c) displaying target symbols associated with prizes that may be awarded upon identification of said identifiable symbols by said player;
(d) enabling player to search for said identifiable symbols within said image;
(e) enabling player to select said identifiable symbols within said image; and
(f) awarding prize to said player for locating identifiable symbols within said image which match a corresponding number of target symbols.
